(19) United States
(12) Patent Application Publication
(10) Pub. No.: US 2004/0054920 A1
(43) Pub. Date: Mar. 18, 2004

(54) Live digital rights management

(76) Inventors: Mei L. Wilson, Redmond, WA (US); Krishnamurthy Ganesan, Redmond, WA (US); Richard W. Saunders, Lake Forest Park, WA (US); Pratul Dublish, Sammamish, WA (US); Brian D. Crites, Redmond, WA (US); Michael Patten, Sammamish, WA (US); James M. Alkove, Woodinville, WA (US)

Correspondence Address: LEE & HAYES PLLC, 421 W RIVERSIDE AVENUE SUITE 500, SPOKANE, WA, 99201

(21) Appl. No.: 10/354,286

(22) Filed: Jan. 30, 2003

Related U.S. Application Data
(60) Provisional application No. 60/407,422, filed on Aug. 30, 2002.

(51) Int. Cl. H04L 9/00

(52) U.S. Cl. 713/200

(57) ABSTRACT

The present disclosure relates to encoding and encrypting digital content, and distributing the encoded digital content to end users. A content provider creates or chooses a digital rights profile that is unique to a license server. The digital content is encoded and encrypted with the digital rights profile as portions of a streaming digital content are immediately received. The encoded digital profile is sent to an end user for rendering. The end user must have a license from the license server to decrypt the encoded digital content. Either the end user has a pre-existing license to decrypt, or must order a license to decrypt the received encoded and encrypted digital content.

### PRIORITY TO PROVISIONAL APPLICATION

This application claims priority to provisional application serial number 60/407,422, filed Aug. 30, 2002.

### TECHNICAL FIELD

The systems and methods described herein relate to enforcing rights in digital content. More specifically, the present invention relates to systems and methods that encode and distribute digital content while protecting it from unauthorized use.

### BACKGROUND

Digital rights management and enforcement is highly desirable in connection with digital content such as digital audio, digital video, digital text, digital data, digital multimedia, etc., where such digital content is distributed to users. Typical modes of distribution include physical media such as a magnetic disk, a magnetic tape, an optical compact disk (CD), digital versatile disk (DVD), posting to an electronic bulletin board, and delivery through an electronic network such as the Internet.

When a user receives the digital content, the user renders or “plays” the digital content with the aid of an appropriate rendering device such as a media player that may reside on a personal computer.

Typically, a content owner or rights-owner, such as an author, a publisher, or a broadcaster (hereinafter “content provider”), wishes to distribute the digital content to a user or recipient in exchange for a license fee or some other consideration. The content owner would likely wish to restrict what the user can do with distributed digital content. For example, the content provider may desire to restrict the user from copying and re-distributing such digital content to a second user.

In addition, the content provider may wish to provide the user with the flexibility to purchase different types of use licenses at different license fees, while at the same time holding the user to the terms of whatever type of license is in fact purchased. For example, the content provider may wish to allow distributed digital content to be played only a limited number of times, only for a certain total time, only on a certain type of machine, only on a certain type of media player, only by a certain type of user, etc.

Through digital rights management (DRM) techniques, digital content may be encrypted by a content provider prior to distribution. The encryption is performed with an encryption key. Users receive the encrypted digital content from the content provider through the typical modes of distribution as discussed above. However, to render such encrypted digital content, users must contact a license server and receive a license that provides a decryption key and associated license rights. Typically, when a user attempts to render the encrypted digital content for the first time, the user is directed to a license server to obtain a license to render the digital content. The license includes the decryption key that decrypts the encrypted digital content and a description of the license rights (e.g., play, copy, etc.) conferred by the license and related conditions (e.g., begin date, expiration date, number of plays, etc.).

The license is stored in the user's computing (rendering) device in a dedicated license store. Since the license is a valuable commodity and must be protected from redistribution, the user device must authenticate itself to the license server prior to obtaining a license. An exemplary method of authenticating between the user device to the license server may involve the use of a tamper proof component, often referred to as a “black box,” that is resident at the user device. The tamper proof component operationally is not visible to the user when a license is requested and received. Further the user cannot modify or tamper with the tamper proof component.

A tamper proof component at the user device may contain a public/private key pair, version number, and a unique signature. The tamper proof component is protected from tampering by any party, and in particular the user.

The public key is made available to the license server for purposes of encrypting portions of the issued license, thereby binding the license to the tamper proof component. The private key is available to the tamper proof component only, and not to the user or anyone else, for purposes of decrypting information encrypted with the corresponding public key. The user device is initially provided with a tamper proof component with a public/private key pair, and the user device is prompted to download updated secure tamper proof component configuration information from a server when the user first requests a license. The server provides the updated tamper proof component configuration information which includes a unique public/private key pair. The updated tamper proof component configuration information may be written in unique executable code that runs only on the user device, and may be re-updated on a regular basis.

When a user requests a license, the user sends the public key, a version number, and a signature to a license server. The license server issues a license only if the version number is current and the signature is valid. A license request may include an identification of the digital content for which a license is requested and a key identifier that identifies the decryption key associated with the requested digital content. The license server uses the public key to encrypt the decryption key, then downloads the encrypted decryption key and the license terms to the user's computing device along with a license signature.

Once the downloaded license has been stored in a license store of the user computing device, the user device can render the digital content according to the rights conferred by the license and specified in the license terms. When a request is made to render the digital content, the tamper proof component decrypts the decryption key, and a license evaluator evaluates such license terms. The tamper proof component decrypts the encrypted digital content only if the license evaluation results in a decision that the user is allowed to play such content. The decrypted content is provided to a rendering application for rendering (playing).

Heretofore, content providers could only protect digital content after an entire stream had been stored in a file such as files defined by Advanced Systems Format (ASF) or Windows Media (WM) format as defined by the Microsoft Corporation. To require that that the entire stream been stored prior to a file prior to protection limits the possibility of streaming live content in real time.

Further, since digital rights management involves separate processes of producing digital content to a file and encoding the digital content file, the digital content may be compromised prior to encrypting.

Also, whenever a content provider desires to encode new digital content, each license server must be contacted and license rights to the new digital content must be created. If a license server is to provide licenses for a number of encrypted digital content from a number of content providers, the license server must contact each content provider and create license rights for each of the encrypted digital contents that the content provider provides.

### SUMMARY

The systems and methods described herein include a content provider computer that sequentially receives a digital content stream that is made of consecutive parts. As the parts are received they are immediately encoded and encrypted without waiting for receipt of the remaining parts of the digital content stream. The encoded and encrypted parts of the digital content stream are distributed immediately to client devices.

In one embodiment encrypting is performed using a unique profile that is created through interaction between the content provider and a license server. In certain embodiments, the profile is first created, while in other embodiments the profile is chosen from a list of profiles that are provide by the license server.

A particular embodiment has the client device receiving the encoded and encrypted content, and decrypting the content using a license from the license server. In particular embodiments, the content provided to the client device includes information as to where the client device may go to get such a license, such as a web-site of the license server.

### BRIEF DESCRIPTION OF THE DRAWINGS

A more complete understanding of exemplary methods and arrangements of the present invention may be had by reference to the following detailed description when taken in conjunction with the accompanying drawings wherein:

FIG. 1 is a block diagram illustrating a system for digital content encoding, encrypting, and distribution to a user for rendering.

FIG. 2 is a flowchart illustrating creation of a digital rights management profile by a content provider and license server.

FIG. 3 is a flowchart illustrating an electronic service for DRM profile management.

FIG. 4 is a diagram illustrating a user interface screen for managing DRM profiles.

FIG. 5 is a diagram illustrating a user interface screen that is displayed when a new DRM profile is created.

FIG. 6 is a diagram illustrating a user interface screen that allows a content provider to add a license server.

FIG. 7 is a diagram illustrating a user interface screen that allows a content provider to set DRM profile rights.

FIG. 8 is a diagram illustrating a user interface screen that allows a content provider to create a new DRM profile for a particular license server.

FIG. 9 is a diagram illustrating a user interface screen that allows a content provider to create a new key and assign rights.

FIG. 10 is a diagram illustrating a general example of a computer that may be used as a content provider computer, a license server computer, and/or a user device computer.

### DETAILED DESCRIPTION

The described embodiments utilize digital rights management (DRM) profiles for license servers. DRM profiles are created by content providers and license servers; are stored by content providers and/or license servers; and are used in encoding digital content.

Exemplary Encoding and Distribution System

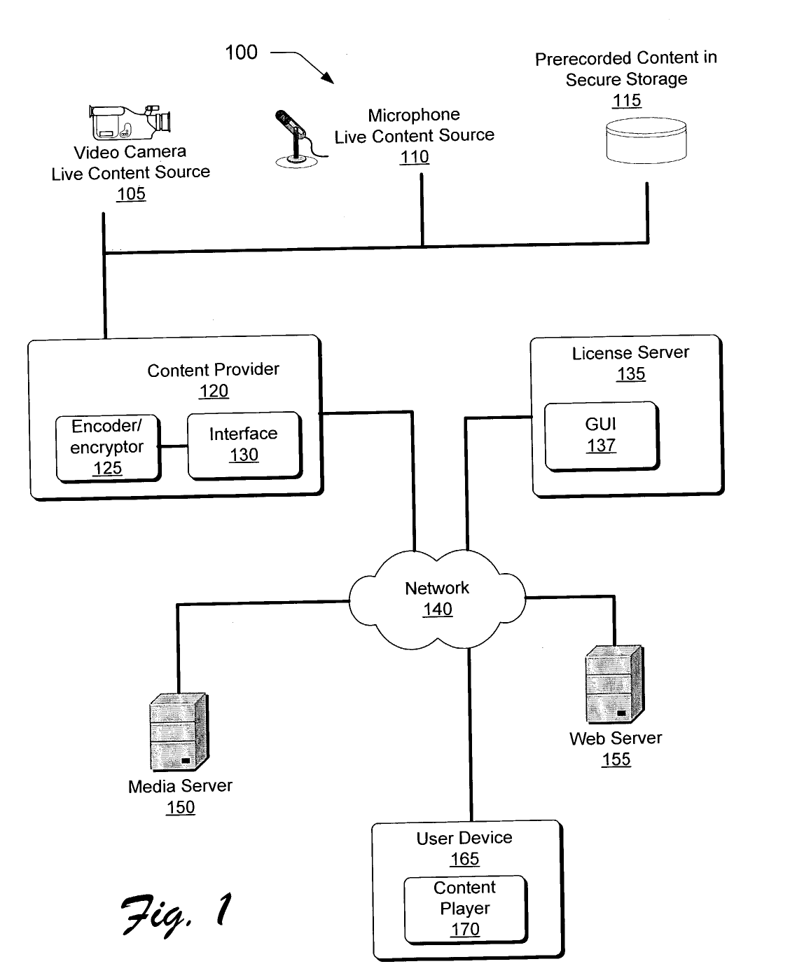

FIG. 1 illustrates a system 100 that encodes and distributes digital content to a user device for rendering. Digital content may come from live content sources such as video as represented by video camera 105 and/or from audio as represented by microphone 110. Digital content may also come from prerecorded digital content in storage 115.

It is contemplated that digital content is streamed to and sequentially received by content provider 120. As the stream of digital content is sequentially 1 received, it is encoded and encrypted by encoder/encryptor 125, without waiting for the remaining stream of non-encoded digital content. In other words each piece of content is encoded and encrypted in real time, as each piece is received. Pieces of content may vary in discernible units as small as bits (ones and zeros) to larger units such as packets or sections of computer readable code.

It is contemplated that encoder/encryptor 125 is implemented as software, hardware or a combination of software and hardware. In certain applications, encoder/encryptor 125 is software that is downloaded to an application program memory of a computing device at the content provider 120. A processor in the computing device is configured to run the encoder/encryptor 125.

A software interface 130 may be part of the content provider 120. The software interface 130 is a set of computer readable software code that connects the content provider 120 to license server 135 through a network 140, where network 140 may include the Internet. Software interface 130 provides for the creation or selection of DRM profiles that are used in encoding.

When a DRM profile is created, the content provider 120 connects to license server 135 through software interface 130. The license server 135 runs code at the content provider 120 side to create the DRM profile. License server 135 may provide a graphical user interface (GUI) 137 to assist an administrator at the content provider 120 in creating the DRM profile.

It is contemplated that encoder/encryptor 125 will store a plurality of DRM profiles, and provide the DRM profiles to the content provider 120. The administrator at content provider 120 may select from DRM profiles stored at the content provider 120 or from DRM profiles provided by a particular license server. Encoder/encryptor 125 through software interface 130 may direct the administrator to a license server site. As mentioned above license server 135 may provide a GUI 137 to the administrator. License server 135 may direct the content provider 120 to a page either at the license server 135, or at another entity, where the administrator chooses rights and/or generic attributes for the digital content as described in a DRM profile.

Whenever encoding takes place for a stream of digital content, a session profile is generated by content provider 120. A key identifier (KID) value, which is an alphanumeric string, is generated and provided to the license server 135 by the encoder/encryptor 125. If the KID value has previously been created and stored by the content provider 120, the stored KID value is merely provided by the content provider 120. The particular KID value becomes part of the session profile. DRM profile information is not required to generate a KID value. Each session profile is associated with the particular DRM profile that is used.

In this example, encoder/encryptor 125 performs the encoding session (i.e., applying a DRM profile to digital content as digital content is received). Encoder/encryptor 125 for each encoding session uses the DRM profile ID, a KID, and a content ID. The content ID is an optional value that identifies a particular digital content stream.

Generally, encoding and encrypting proceeds as follows. The content provider 120 specifies a KID to the license server 135. Alternatively, if no KID is specified, the license server 135 queries the encoder for a KID. License acquisition uniform resource locator (LAURL), which provides information as to where a license may be acquired by an end user device, is generated by the license server 135 and saved at encoder/encryptor 125. The license server 135 passes certificate strings such as a signature certificate and a license server certificate to encoder/encryptor 125 as part of content header signing certificates.

The encoder/encryptor 125 uses this information to encode and encrypt the digital content and sends the encoded and encrypted digital content to network 140. Encoded and encrypted digital content may be received and stored in a media server 150. Alternatively the digital content may be streamed, as it is encoded and encrypted, to one or more user devices, such as user device 165.

Web server 155 may contain and provide web page(s) and underlying functionality for creating DRM profiles for the license server 135 with various content providers. Web server 155 may also contain a web page associated with a particular LAURL for users to obtain licenses. License server 135 and web server 155 may be connected to one another through network 140.

An end user device 165 receives digital content as it is encoded and encrypted, and renders the encoded and encrypted digital content on content player 170 after it decrypts and decodes the content. In this example the encoded and encrypted digital content is received through network 140.

Alternatively, encoded and encrypted digital content may be delivered to end user device 165 through media server 150. End user device 165 may either have a license resident on its computing device, or must acquire such a license in order to decrypt the encoded digital content. In this example, end user device 165 contacts license server 135 for a license. End user device 165 may also contact other license servers for a license. Since end user device 165 may initiate contact with the content provider, and receive the encoded digital content, the end user device 165 may request information as to where to go to acquire a license. The LAURL therefore is provided in the encoded digital content header, and is viewable by the end user device 165 without a license.

With the license the content player 170 decrypts the encoded digital content and plays back (renders) the digital content.

DRM Profile

A DRM profile associated with a license server is stored at a content provider and is used to encode digital content. A DRM profile is a data structure that may contain the following parameters and information. The use of these parameters and information will be discussed in more detail in the following sections.

Profile Identifier—“Profile identifier” is a read only property that may be chosen by a content provider and is unique to the content provider. A license server that deals with multiple content providers ensures that “profile identifier” is unique across all the content providers. It is contemplated in a system having multiple content providers, DRM profiles may be maintained in a central location, and the system will assure that DRM profiles will not have the same “profile identifier.” Individual content providers may be able to look up DRM profiles from the central location, based on their unique “profile identifier” and only be able see their particular DRM profiles, and not other content providers' DRM profiles.

Seed—“Seed” is a property of a content provider that is only known by the content provider. “Seed” is a hidden property and will be encrypted when stored on the content provider's local machine. “Seed” is exchanged with a license server when a new DRM profile is created. Since “seed” is unique to the content provider, “seed” is used to create DRM profiles that are unique to the content 9 provider and license servers. In other words, with the use of “seed,” DRM profiles for a particular content provider are unique to that content provider. “Seed” information will only be exchanged to the license server when a DRM profile is created. “Seed” information can not be retrieved after the DRM profile is created. “Seed” and key identifier (KID) are used by the license server to generate a content decryption key which is also the content encryption key.

Public Key—“Public key” is a read only property exchanged with a license server. In a multiple content provider system with multiple “profile identifiers,” “public key” information may be made available when a DRM profile is configured (created) to assure that a DRM profile that is identified by a particular “profile identifier” has a matching public key for a particular encoding session configuration file. Public key is used by the license serer to verify that content header has not been altered, after the public key is generated and signed by the content provider.

Private Key—“Private key” is encrypted and stored on a content provider's local machine. Only the content provider's local machine knows about the “private key” and “information.” Generally a “private key” is used to decrypt an encrypted message (e.g., communication from a license server). The private and public key pairs form an asymmetric key pair for authenticating purposes. Private key corresponds with public key.

Signature Signing Key—“Signature signing key” is a string provided by a content provider to a license server when a DRM profile is created. “Signature signing key” is used to sign content header information, allowing an end user to know whether the content has been tampered with. The signature signing key may be the same as the private key.

Signature Certificate—“Signature certificate” is a string provided by a license server when a DRM profile is created. “Signature certificate” is used for content header signature certificate, and allows an end user to know whether the content header has been tampered with.

License Server Certificate—“License server certificate” is a string provided by a license server when a DRM profile is created. This information is used by a user to verify the license server.

Root Certificate—“Root certificate” is a string provided by a license server when a DRM profile is created. “Root certificate” information is used for verifying the license server is certified with a root party (e.g., DRM software provider). The license server certificate and the root certificate make up a certificate chain that may be used to verify a license server's certificate and the signature certificate as signed by the license server.

Provider Uniform Resource Locator (URL)—“Provider URL” is a read only property that is set when a DRM profile is created. This information contains the URL to go to, in order to modify the DRM profile.

License Acquisition URL—“License Acquisition Uniform Resource Locator” (LAURL) is information given by a license server when a DRM profile created. When a user identifies a particular DRM profile of a particular license server, LAURL is the default URL of the particular license server from which a license is received. It is contemplated that a license server will have one LAURL dedicated for license acquisition support. Therefore the need to change this information may be infrequent.

Generic Attributes—“Generic attributes” are name/value pairs specified g by a license server that define additional DRM configuration settings. “Generic attributes” are general to all DRM profiles for the license server. An example of a “generic attribute” is a version reference used by an end user when rendering encoded digital content. Another example of a “generic attribute” is a rights label attached to the header of a digital content. Since a license server specifies “generic attributes,” the license server may disregard certain “generic attributes” at times, such as rights label. In this instance, rights labels information may be resident on the license server's database. Modification of rights label can therefore be made from the database instead of modifying the DRM profile.

Creation of a DRM Profile

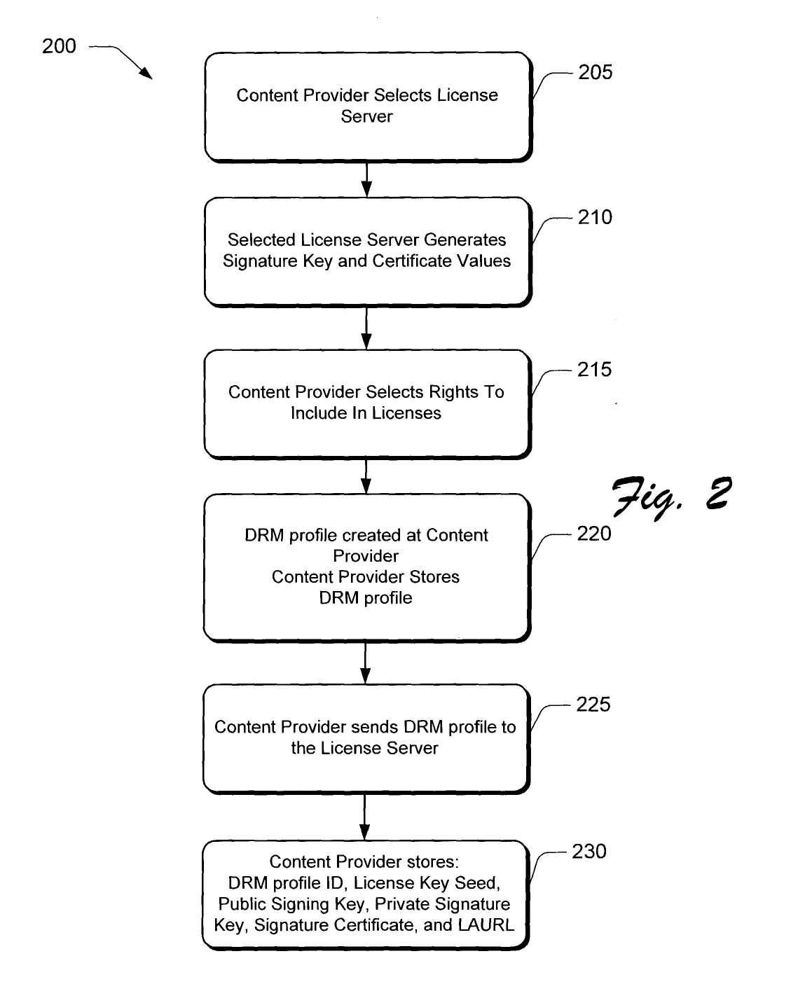

FIG. 2 is a flowchart 200 illustrating the creation of a license server DRM profile. At block 205, an administrator at a content provider selects a license server. This may be performed by the administrator by contacting a particular license server to generate a DRM profile. The license server can be an in-house license service or a third-party license service. In either case, the content provider may interact with the license server via web pages. The web pages are developed for the license server and provide information to the administrator. Communication between the content provider and the license server should be secure. An example of secure communication would be the implementation of secure socket layer (SSL). A license server may be chosen from a list of license servers that is resident at the content provider, or the content provider may go to another server to get a list of license servers.

At block 210, the license server generates “signature signing key” and “signature certificate” values. In particular, the license server initiates code to be run at the content provider to generate the “signature signing key” and “signature certificate” values. As discussed above, “signature signing key” and “signature certificate” are used to create signature values that may be used in the content header. These actions may be performed through interface 130 of FIG. 1.

At block 215, the license server queries the administrator of a content provider as to desired rights to include in licenses of the digital content. This action may be performed through the use of interface 130 of FIG. 1. Rights may include the number of times the digital content is allowed to be played (rendered); the duration of rights (e.g., one month to play the digital content, or unlimited); and reproduction rights (i.e., the ability to create copies).

At block 220, the DRM profile is created and stored at the content provider side. The DRM profile includes the license key seed, the public signing key, and the private signing key.

At block 225, the content provider sends to the license server (or the license server retrieves) the DRM profile. The values included in the DRM profile to issue licenses may include the DRM profile ID, license key seed, public signing key, and selected generic rights.

At block 230, the content provider stores the DRM profile which may include the same DRM profile ID, license key seed, and public signing key as stored at the license provider, along with the private signing key, signature certificate, and LAURL.

Content providers may have multiple DRM profiles. By having multiple DRM profiles, a content provider is able to use more than one license server. A content provider having multiple DRM profiles for one license server allows the content provider to change seed, public and private key pairs for the license server at regular intervals.

Exemplary Electronic Service for DRM

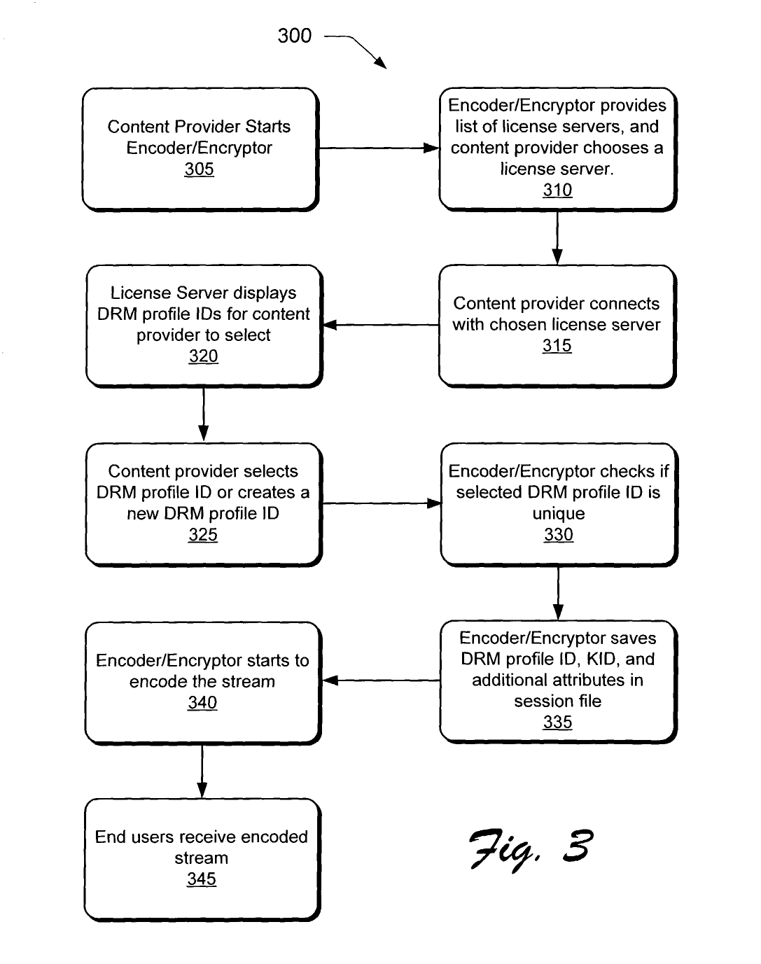

FIG. 3 is a flowchart 300 illustrating an electronic service for DRM profile management. Referring back to FIG. 1, content provider 120, encoder/encryptor 125, license server 135, a GUI 137, and user device 165 interact as described by flowchart 300. In general, encoder/encryptor 125 receives, encodes, and encrypts digital content. Prior to encoding and encrypting, the content provider 120 selects a license server such as licenser 135. A DRM profile is chosen or created by the content provider 120, where the GUI 137 may be used to choose or create such a DRM profile. Once the DRM profile is chosen, the encoder/encryptor 125 begins encoding and encrypting pieces of digital content as they are received. The digital content is sent out to a user device such as user device 165 as soon as the digital content is encoded and encrypted.

Referring now to FIG. 3, at block 305, a content provider activates an encoder/encryptor, such as encoder/encryptor 125 described in FIG. 1. The encoder/encryptor may present a graphical user interface to the content provider to select a license server.

At block 310, the encoder/encryptor provides a list of license servers to the content provider. Certain embodiments provide for a description of each of the license servers on the list.

At block 315, the content provider selects a license server. The encoder/encryptor directs the content provider to the license server's home page. The content provider identifies itself to the license server over a secure web site. It is contemplated that the secure web site is authored by the license server and is accessible only to registered content providers. Therefore, if it is the first time the content provider uses the particular license server, registration is performed. After the content provider is identified, a configuration page from the license server is provided.

At block 320, the license server displays available profile IDs for the user. The license service may also list the various generic attributes that may be associated with the particular profile IDs. The profile IDs and generic attributes may be displayed in a web page.

At block 325, the content provider may select an available DRM profile ID from the displayed list, and specify generic attributes from the displayed list to be used in the encoding session. If a new DRM profile is created, the encoder sends a seed and public key to the license server.

At block 330, the encoder/encryptor checks to see if the DRM profile ID is unique. An error is returned from the encoder/encryptor to the license server if the DRM profile ID is not unique. Otherwise, the encoder/encryptor generates a seed and public key and private key pair that are saved, along with the DRM profile ID, license acquisition info (e.g., LAURL), and optionally generic attributes on the encoder/encryptor.

At block 335, for each encoding and encrypting session a session file is created. The encoder/encryptor saves the DRM profile ID, the KID, and additional generic attributes to a session file.

At block 340, encoding and encoding may begin. Content provider receives the stream of digital content and the encoder/encryptor encodes and encrypts the digital content for distribution to end users.

At block 345, end users received encoded and encrypted digital content. In certain cases, an end user will have the license to decrypt the encoded and encrypted digital content, such as in the case when the end user pre-orders the license prior to receiving encoded and encrypted digital content. In other cases, the end user receives the encoded and encrypted digital content then contacts a license server for the licenses.

Exemplary DRM Session Dialog User Interface Screens

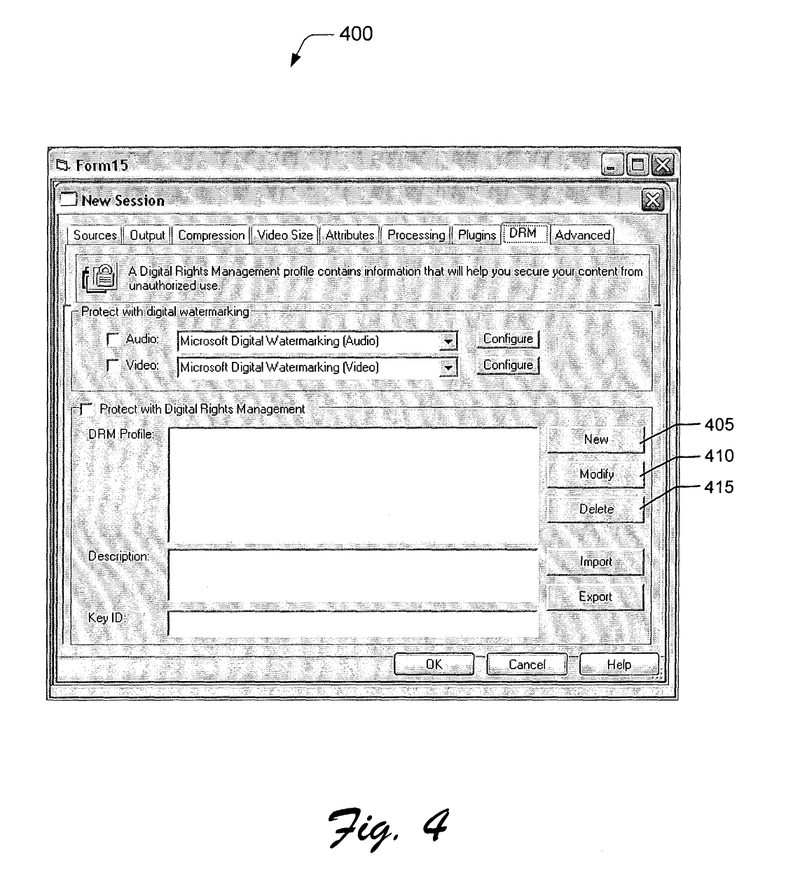

FIG. 4 is a screen 400 for a session to manage DRM profiles. An administrator at a content provider is able to select from a number of actions to manage DRM profiles. Options include creating a new DRM profile by choosing the New button 405; changing a DRM profile by choosing Modify button 410; or removing a DRM profile by choosing Delete button 415.

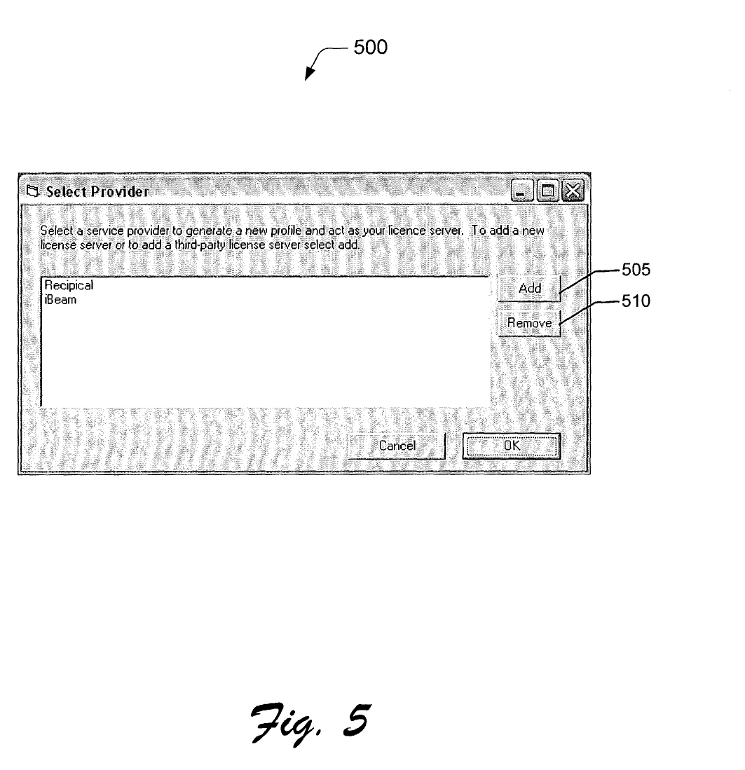

FIG. 5 is a screen 500 that is displayed when a new DRM profile is created. Screen 500 appears if the New button 405 of FIG. 4 is chosen. An administrator at a content provider is asked to select from a list of license servers by highlighting a particular license server. Screen 500 further allows the administrator to add a license server through Add button 505, or remove a license server by Remove button 510. The list of license servers may be resident at the content provider computing device, and/or may be provided from a database resident in another computing device.

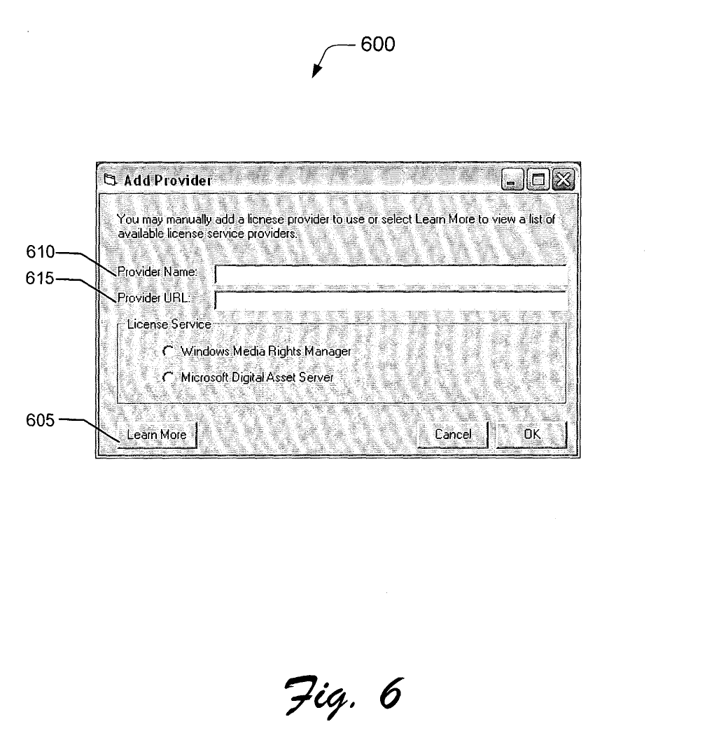

FIG. 6 is a screen 600 that allows an administrator at a content provider to add a license server. If the Add button 505 of screen 500 is chosen, screen 600 appears for the content provider. If the administrator desires to find out more information about, or merely find a license server, Learn More button 605 may be activated. Activating Learn More button 605 sends the content provider to a web site that lists license servers. When the administrator knows the license server to be added, the Provider Name 610 (i.e., license server name) and Provider URL (i.e., license server URL) fields are entered by the administrator.

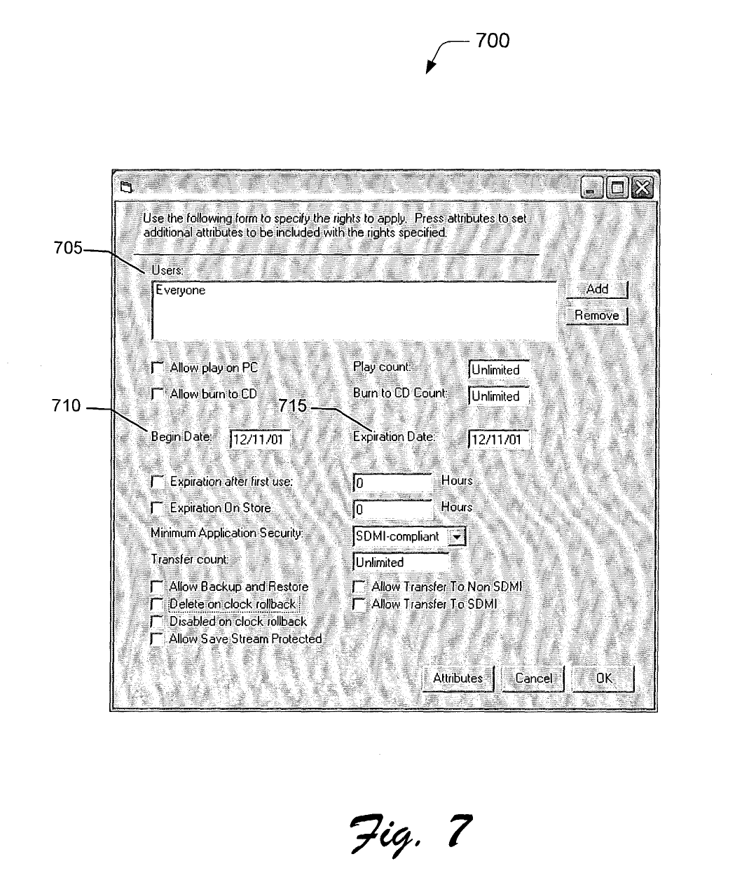

FIG. 7 is a screen 700 that allows the administrator to set DRM profile rights. Options made available to the administrator include defining the Users 705, including the ability to add and remove users. The administrator may also define when the digital content may be played by defining a begin date field 710 and an expiration date field 715.

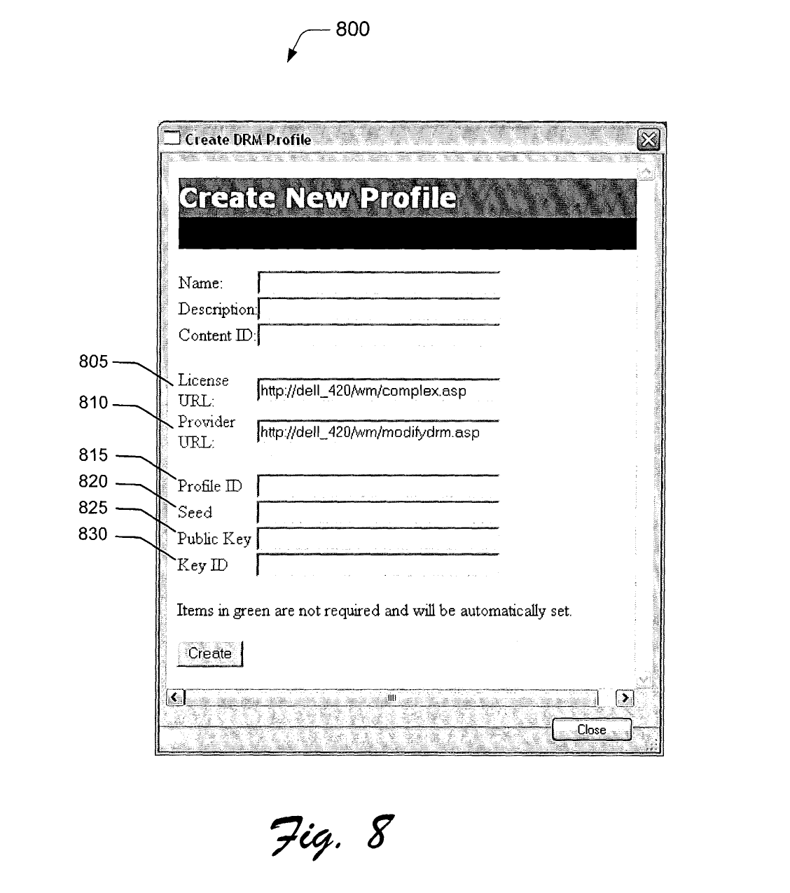

FIG. 8 is a screen 800 that allows the administrator to create a new DRM profile for a particular license server. Once the administrator has selected a license server, screen 800 is displayed. The license server provides the following fields: License URL 805, Provider URL 810, Profile ID 815, Seed 820, and Public key 825. In other words, these fields are automatically entered by the license server. Although KID is not part of a profile, the particular KID value associated with the profile may be includes as the field KID 830.

When a new DRM profile is created new public and private keys are automatically generated. An administrator at a content provider may need to specify what rights are to be specified for the new Key ID and content ID defined by the new public and private keys. Rights are part of licenses that are issued and not part of the digital content. The rights are applied to the license when the license is generated. Therefore the rights may or may not be specified when the DRM profile is created. However, rights should be specified before an end user attempts to get a license. The license server should also provide a default set of rights for digital content that does not have specific rights.

When a new KeyID is created, rights should be associated with the new KeyID. When an end user receives encoded digital content and the end user requests a new license, the license server can use the new KeyID to look up which rights to apply to the license.

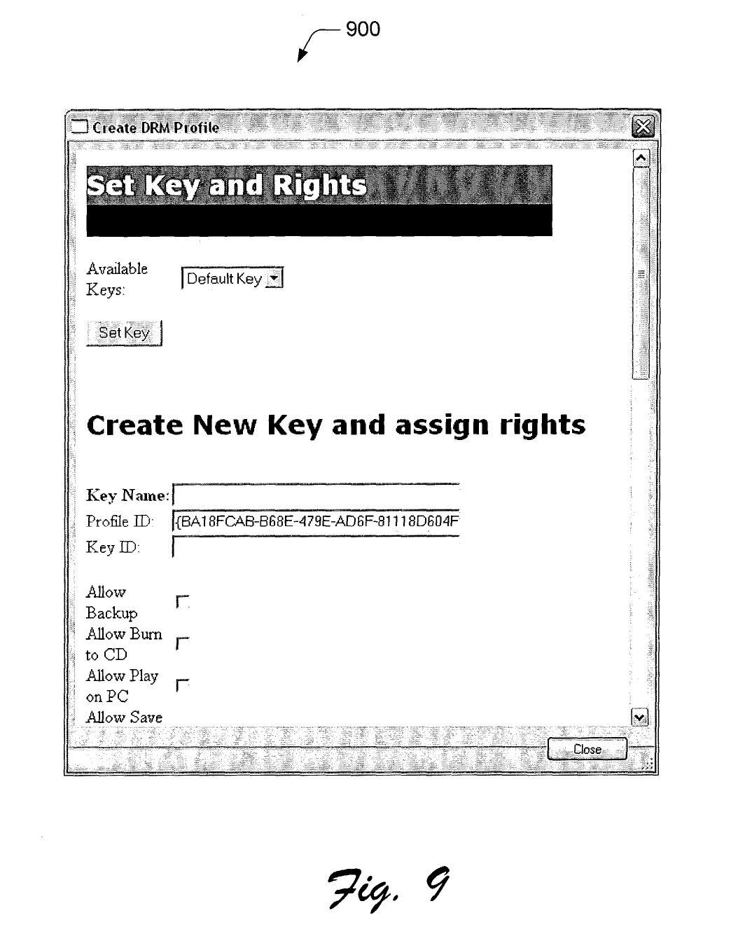

FIG. 9 is a screen 900 that allows an administrator at a content provider to create a new key and assign rights. In this example, rights properties simply update the database on the license server so when a license request is made, the server knows what rights to apply. A single DRM profile can support multiple key IDs. Content providers may choose an existing key ID or choose to create a new Key ID. This allows the administrator to create encoded digital content that may be decrypted by using an existing license, or create encoded digital content that is encrypted using a new and unique license.

Exemplary Computer Environment

The subject matter is described in the general context of computer-executable instructions, such as program modules, being executed by one or more conventional personal computers. Generally, program modules include routines, programs, objects, components, data structures, etc. that perform particular tasks or implement particular abstract data types. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. In a distributed computer environment, program modules may be located in both local and remote memory storage devices.

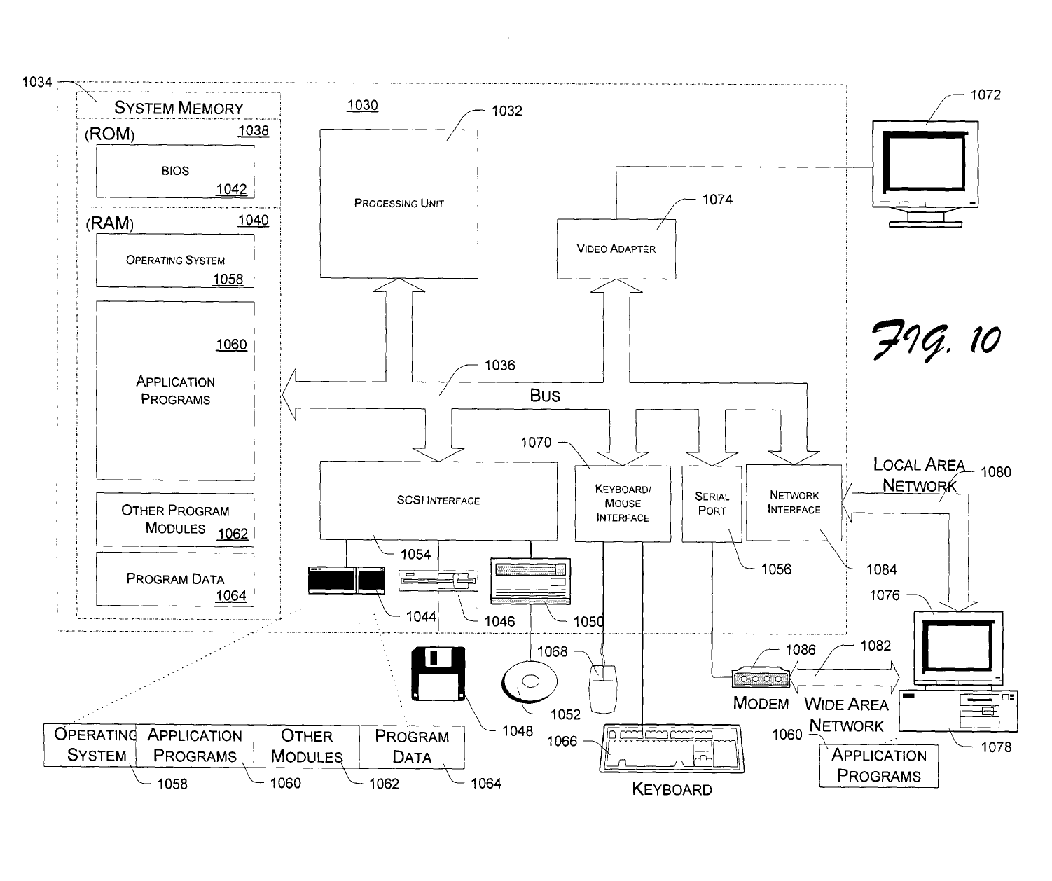

FIG. 10 shows a general example of a computer 1030 that is used in accordance with the subject matter. Computer 1030 is shown as an example of a computer that can perform the functions of a content provider computer, a license server computer, and/or a user device computer. Computer 1030 includes one or more processors or processing units 1032, a system memory 1034, and a bus 1036 that couples various system components including the system memory 1034 to processors 1032.

The bus 1036 represents one or more of any of several types of bus structures, including a memory bus or memory controller, a peripheral bus, an accelerated graphics port, and a processor or local bus using any of a variety of bus architectures. The system memory includes read only memory (ROM) 1038 and random access memory (RAM) 1040. A basic input/output system (BIOS) 1042, containing the basic routines that help to transfer information between elements within computer 1030, such as during start-up, is stored in ROM 1038. Computer 1030 further includes a hard disk drive 1044 for reading from and writing to a hard disk, not shown, a magnetic disk drive 1046 for reading from and writing to a removable magnetic disk 1048, and an optical disk drive 1050 for reading from or writing to a removable optical disk 1052 such as a CD ROM or other optical media. The hard disk drive 1044, magnetic disk drive 1046, and optical disk drive 1050 are connected to the bus 1036 by an SCSI interface 1054 or some other appropriate interface. The drives and their associated computer-readable media provide nonvolatile storage of computer readable instructions, data structures, program modules and other data for computer 1030.

Although the exemplary environment described herein employs a hard disk, a removable magnetic disk 1048 and a removable optical disk 1052, it should be appreciated by those skilled in the art that other types of computer readable media which can store data that is accessible by a computer, such as magnetic cassettes, flash memory cards, digital video disks, random access memories (RAMs) read g only memories (ROM), and the like, may also be used in the exemplary operating environment.

A number of program modules may be stored on the hard disk, magnetic disk 1048, optical disk 1052, ROM 1038, or RAM 1040, including an operating system 1058, one or more application programs 1060, other program modules 1062, and program data 1064.

A user may enter commands and information into computer 1030 through input devices such as keyboard 1066 and pointing device 1068. Other input devices (not shown) may include a microphone, joystick, game pad, satellite dish, scanner, or the like. These and other input devices are connected to the processing unit 1032 through interface 1070 that is coupled to bus 1036. Monitor 1072 or other type of display device is also connected to bus 1036 via an interface, such as video adapter 1074.

Computer 1030 operates in a networked environment using logical connections to one or more remote computers, such as a remote computer 1076. The remote computer 1076 may be another personal computer, a server, a router, a network PC, a peer device or other common network node, and typically includes many or all of the elements described above relative to computer 1030, although only a memory storage device 1078 has been illustrated in FIG. 10. Computer 1076 is shown as an example of a computer that can perform the functions of a client computer 238 of FIG. 2. The logical connections depicted in FIG. 10 include a local area network (LAN) 1080 and a wide area network (WAN) 1082. Such networking environments are commonplace in offices, enterprise-wide computer networks, intranets, and the Internet.

When used in a LAN networking environment, computer 1030 is connected 9 to the local network 1080 through a network interface or adapter 1084. When used in a WAN networking environment, computer 1030 typically includes a modem 1086 or other means for establishing communications over the wide area network 1082, such as the Internet. The modem 1086, which may be internal or external, is connected to the bus 1036 via a serial port interface 1056. In a networked environment, program modules depicted relative to the personal computer 1030, or portions thereof, may be stored in the remote memory storage device. It will be appreciated that the network connections shown are exemplary and other means of establishing a communications link between the computers may be used.

Generally, the data processors of computer 1030 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory.

The subject matter described herein includes these and other various types of computer-readable storage media when such media contain instructions or programs for implementing the steps described below in reference to FIG. 10 in conjunction with a microprocessor or other data processor.

The subject matter also includes the computer itself when programmed according to the methods and techniques described below. Furthermore, certain sub-components of the computer may be programmed to perform the functions and steps described below. The subject matter includes such sub-components when they are programmed as described. In addition, the subject matter described herein includes data structures, described below, as embodied on various types of memory media.

For purposes of illustration, data, programs and other executable program components, such as the operating system are illustrated herein as discrete blocks, although it is recognized that such programs and components reside at various times in different storage components of the computer, and are executed by the data processor(s) of the computer.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A digital rights management method comprising:
sequentially receiving parts of a digital content stream;
encoding and encrypting the parts of the digital content stream as they are received, without waiting for reception of all parts of the digital content stream; and
distributing the encoded parts of the digital content stream as they are encoded, without waiting for encoding of all parts of the digital content stream.

2. The method of claim 1 wherein encoding is performed with a profile associated with a license server.

3. The method of claim 2 wherein the profile comprises a name; a profile identifier; a seed, a public key, and a private key.

4. The method of claim 3 wherein the profile further comprises a signature signing key, a signature certificate, a license server certificate, a uniform resource locator (URL) to the license server, a license acquisition URL, and a set of attributes.

5. The method of claim 1 wherein the digital content stream is a live broadcast.

6. The method of claim 1 wherein the digital content stream is from a secure media storage.

7. The method of claim 1 wherein the distributing is performed over the Internet.

8. A method comprising:
encoding and encrypting a stream of digital content based on a profile associated with a license server;
distributing the encoded stream of digital content; and
rendering the encoded stream of digital content with a license provided by the license server.

9. The method of claim 8 wherein the license server is selected from a list of license servers resident at a content provider.

10. The method of claim 8 wherein a content provider fetches a list of license servers from a second server from which the license server is selected.

11. The method of claim 8 wherein the stream of digital content is comprised of parts, wherein encoding is performed as each part is received, and distributing is performed as part is encoded.

12. The method of claim 8 wherein the license is accessed at the license server as identified by a license acquisition uniform resource locator.

13. The method of claim 8 wherein the profile defines unique information associated with the license server.

14. The method of claim 8 wherein the profile is created with the license server.

15. The method of claim 8 wherein the profile is chosen from a list provided by the license server.

16. The method of claim 15 wherein the license server provides an interface to chose the profile.

17. The method of claim 8 wherein the profile comprises a name; a profile identifier; a seed, a public key, and a private key.

18. The method of claim 17 wherein the profile further comprises a signature signing key, a signature certificate, a license server certificate, a provider uniform resource locator (URL), a license acquisition URL, and a set of attributes.

19. The method of claim 8 wherein the distributing is performed over the Internet.

20. A method comprising:
contacting a license server;
determining a set of unique information associated with the license server and a content provider; and
creating a profile based on the set of unique information.

21. The method of claim 20 wherein creating a profile comprises sending a public key and seed to the license server.

22. The method of claim 20 wherein the unique set of information comprises a name; a profile identifier; a seed, a public key, and a private key.

23. The method of claim 22 wherein the unique set of information further comprises a signature signing key, a signature certificate, a license server certificate, a provider URL, a license acquisition URL, and a set of attributes.

24. The method of claim 20 further comprising encoding a digital content with the profile.

25. The method of claim 24 wherein the encoding comprises encoding parts of the digital content as they are received, without waiting for reception of all parts of the digital content.

26. The method of claim 20 wherein contacting is performed over the Internet.

27. A method of distributing a digital content comprising:
creating a profile for a license server;
encoding the digital content with the profile;
sending the encoded digital content to a user; and
rendering the encoded digital content with a license provided by the license server.

28. The method of claim 27 wherein the digital content comprises parts that are sequentially received.

29. The method of claim 28 wherein the parts are encoded and sent as they are received without waiting for the encoding of the remaining parts of the digital content.

30. The method of claim 27 wherein the sending is performed over the Internet.

31. A method of creating a license server profile at a content provider comprising:
selecting a license server;
generating an identifier for the license server profile;
specifying information associated with the license server profile;
creating a digital signature, a seed, a public signing key, and a private signing key that are associated with the license server profile;
storing the digital signature, the seed, and the public and private signing key pair at the content provider; and
sending the digital signature, the seed, and the public key to the license server, wherein the license server issues a license to an end user using the digital signature, license key seed, and the public key.

32. The method of claim 31 wherein selecting a license server is performed from a list of license servers resident at the content provider.

33. The method of claim 31 wherein selecting a license server is performed from a list of license servers resident at a second server.

34. The method of claim 31 wherein the digital signature is stored in a content header.

35. The method of claim 31 wherein the license server profile is used to encode a digital content.

36. An encoding and encrypting device that encodes and encrypts digital content comprising:
memory to store a profile from a license server;
an input device to receive digital content, wherein the digital content is encoded and encrypted with the profile; and
an output device to distribute the encoded and encrypted digital content.

37. The device of claim 36 wherein the digital content is comprised of parts and the parts are encoded and encrypted as they are received, and distributed as they are encoded and encrypted without waiting for the reception of the remaining parts.

38. An encoding and encrypting device that encrypts digital content comprising:
a programming interface to access a profile from a license server;
an input device to receive digital content, wherein the digital content is encoded and encrypted with the profile; and
an output device to distribute the encoded and encrypted digital content.

39. The device of claim 38 wherein the digital content is comprised of parts and the parts are encoded and encrypted as they are received, and distributed as they are encoded and encrypted without waiting for the reception of the remaining parts.

40. The device of claim 38 wherein the profile is created by the encoding and encrypting device and the license server.

41. The encoding device of claim 38 wherein the profile is chosen from a list of profiles provided by the license server.

42. The encoding device of claim 38 wherein the profile creation is initiated from a web-site after which the profile will reside on the content provider.

43. The encoding device of claim 38 wherein the accessing the profile is performed over the Internet.

44. The encoding device of claim 38 wherein the encrypted content is distributed over the Internet.

45. A media player comprising:
a receiving device to receive encoded digital content comprising a license acquisition uniform resource locator, and
a programming interface to the license server to receive a license to decrypt the encoded digital content.

46. The media player of claim 45 wherein the license is received from a license server web-site as defined by the license acquisition uniform resource locator.

47. A network comprising:
a content provider;
a license server, wherein a profile of the license server is generated by the content provider and the license server; and
a rendering device, wherein the rendering device receives a digital content encoded with the profile of the license server from the content provider and receives a license from the license server to decrypt the digital content encoded with the profile of the license server.

48. A computer-readable medium comprising computer-executable instructions for encoding and encrypting digital content comprising instructions for:
accessing a profile from a license server;
receiving digital content, wherein the digital content is encoded and encrypted with the profile; and
distributing the encoded and encrypted digital content.

49. The computer-readable medium of claim 48 wherein the digital content is comprised of parts and the parts are encoded and encrypted as they are received and distributed without waiting for receipt of the remaining parts of the digital content.

50. The computer-readable medium of claim 48 wherein the profile is based on a unique set of information that comprises a name; a profile identifier; a seed, a public key, and a private key.

51. The computer-readable medium of claim 48 wherein the profile is assessed from a list of profiles located at the license server.

52. The computer-readable medium of claim 48 wherein receiving is from a live broadcast.

53. The computer-readable medium of claim 48 wherein receiving is from a secure media storage.

54. A computer-readable medium comprising computer-executable instructions for rendering encoded digital content comprising instructions for:
receiving digital content encoded with a profile associated with a license server;
receiving a license to decrypt the encoded digital content, from the license server; and
rendering the encoded digital content.

55. The computer-readable medium of claim 54 wherein the digital content is comprised of parts and the parts are received as they are encoded and rendered without waiting receipt of the remaining parts of the digital content.

56. The computer-readable medium of claim 54 wherein the license is received through a web-site defined by a license acquisition uniform resource locator.

57. A computer-readable medium having stored thereon a data-structure comprising:
a first data field containing a name;
a second data field containing a profile identifier;
a third data field containing a seed;
a fourth data field containing a public key; and
a fifth data field containing a private key.

58. The computer-readable medium of claim 57 further comprising:
a sixth data field containing a signature signing key;
a seventh data field containing a signature certificate;
an eighth data field containing a license server certificate;
a ninth data field containing a uniform resource locator (URL) to a license server;
a tenth data field containing a license acquisition URL; and
an eleventh data field containing attributes.
